(19) United States
(12) Patent Application Publication
(10) Pub. No.: US 2015/0256351 A1
(43) Pub. Date: Sep. 10, 2015

(54) Live Event Social Media

(71) Applicants: Jerry Dwayne Murphy, Greenville, NC (US); Collin Eugene Peregoy, Dunn, NC (US)

(72) Inventors: Jerry Dwayne Murphy, Greenville, NC (US); Collin Eugene Peregoy, Dunn, NC (US)

(21) Appl. No.: 14/200,603

(22) Filed: Mar. 7, 2014

(51) Int. Cl. H04L 12/18; H04L 29/08

(52) U.S. Cl. CPC H04L 12/1813; H04L 67/18

(57) ABSTRACT

The present invention relates to a social media site designed for persons attending a live event to meet and socialize during the live event. By collecting each person at the event on a single website, anyone present can be found and contacted using social media.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to social media. In particular, the present invention relates to a social media for individuals attending a specific live event.

2. Description of Related Art

The attendance of an individual at a live event has certain mystic appeal about it compared to recorded performances of music, theater and the like. People attend those performances frequently in their own neighborhoods and communities. Less frequently in areas they may travel to. The effect of an audience laughing, applauding or enjoying the performance together is not nearly the same interactive piece of entertainment as seeing such performance in a recorded situation. With the advent of the internet, finding these venues and performances of interest has become easier and even specialty performances can easily be found to attend at virtually any location.

The interactive nature of an audience is primarily limited to the group acting in the concert since due to seating limitations one can only interact with those in seats relatively near one's own seating. As such, there is little reason to go to a live event for an interactive individual event though such would increase the interest and entertainment value of attending a live event. Other means for individuals reacting at a live event then would be an advance in entertainment value.

### BRIEF SUMMARY OF THE INVENTION

The present invention relates to individuals attending live entertainment events using a specialized social media site to chat to other individuals also at the same live entertainment event. It is found that by coordinating a chat through a specialized media site rather than just a regular chat site more and specialized contact can be obtained than by previous sites available for chat or social interaction.

Accordingly, in one embodiment of the invention there is a system for the interaction of people using a social media site comprising:
a) a social media website associated with a live entertainment event;
b) a website interface that allows a plurality of website users attending the live event to become associated with the live entertainment event through the website;
c) a communication system associated with the website that allows the users attending the live event to communicate with one another during the live event.

In another embodiment of the present invention there is a method of using a social media website and communication system comprising:
a) providing a social media website having a user interface and associating the website with a communication system and a live entertainment event;
b) allowing a plurality of users attending the live event to access the social media website via the user interface;
c) providing a means for the users attending the live event to access each other via the social media website;
d) allowing the users access to the communication system in order for the users to communicate with users they have accessed during the live event.

### BRIEF DESCRIPTION OF THE DRAWINGS

FIG. 1 is a diagram of the social media/communication system of the present invention.

FIG. 2 is a relationship chart between the website users and the communication system of the invention.

FIG. 3 is a flow chart of the method of using the social media site of the present invention.

### DETAILED DESCRIPTION OF THE INVENTION

While this invention is susceptible to embodiment in many different forms, they are shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “live entertainment event” refers to a location such as a building or a performance venue where people come together to share a common entertainment event. Events such as music performances, theater, fairs, movies, bars, clubs, restaurants and the like. The event itself does not have to be live but the users must be “live” at the entertainment venue. In one embodiment, the event and the people are both live. In another embodiment there is a live performance being watched by users. In one embodiment it is anticipated that the attendance by users is sufficiently large that the users would have difficulty finding people they knew or meeting everyone. While not desiring to be bound by limitations of users, an event with 50 to 100 or more users and in some cases 1000 users or more are contemplated.

As used herein the term “social media website or outlet” may refer generally to any system, network, and/or outlet configured to facilitate interaction and/or the distribution of communications and/or content between one or more users. In one embodiment it is a website. For example, social media outlets may include internet-based applications configured to facilitate interaction between users. Exemplary social media outlets may include collaborative projects (e.g., Wikipedia), social networking sites (e.g., Myspace, Twitter, Facebook), media sharing sites (e.g., Flickr, YouTube), review/opinion sharing sites (e.g., epinions, WikiAnswers), internet forums, blogs (e.g., weblogs, social blogs, microblogs), content communities, virtual game worlds, virtual communities, and/or any other type of social media outlet. Social media outlets may be configured to facilitate the distribution of posts (e.g., wall postings, blog postings), emails, instant messages, media content, and/or any other suitable communications or other content. A user may utilize a social media outlet to connect, network, and/or communicate with other social media users.

As used herein the term “a social media website user” refers to an individual user that accesses the social media website via a portable computer such as a laptop or smart phone, for the purpose of communicating with other individuals at the live entertainment event who are also users of the social media website. Users would be able to sign into a particular live event and see who is also at the event and chat or use the information to find each other at the event.

As used herein the term “communication system” refers to a system for users of the website to communicate with one another at a live entertainment event. For example, a type chat function or a web camera based system wherein the user must sign into the system and be on the system is contemplated. In general, the communication to and from the website will be a wireless method known in the art.

As used herein the term “website” used in this document refers to a logical location (e.g., an internet or intranet location) identified by a URL, or it refers to a web server hosting the web site represented by the URL. For example, some “websites” are distributed over multiple internet or network locations, but have a shared web server(s) hosting those locations, and in many situations it is logical to consider those network locations to all be part of “a website.”

As used herein the term “user interface” describes any device, app, GUI or group of devices for presenting and/or receiving information and/or directions to and/or from the website. A user interface may comprise a means to present information to persons, such as a visual display projector or screen, chat, a Braille device, a vibrating device, or the like. A user interface may also include a means to receive information or directions from the website (from other users and the website), such as one or more or combinations of buttons, keys, levers, switches, knobs, touch pads, touch screens, microphones, speech detectors, motion detectors, cameras, and light detectors. Exemplary user interfaces comprise web pages, mobile phones, laptop computers, handheld and smart computers, personal digital assistants (PDAs), keyboards, keypads, liquid crystal displays (LCDs), control panels, and speech recognition devices.

As used herein the term “associating” or “associated” refers to include direct and/or indirect coupling of separate items and/or one item being embedded within another item. The association provides a desired relationship between the items being associated. For example, where a website is associated with a communication system the communication system is usable by website users who are accessing (and being associated with) the website.

As used herein the term “access” refers to the system allowing the plurality of users to view and use the website and the communication system thereon. The users may have to pay a fee, sign in, have a password, fill in user information and the like to gain access to the website either by using an app to access the website or signing in the website using the URL or the like. One skilled in the art understands how one can access a website and how that could be limited so that only desired users can access it. One can easily have users register for a live event or use GPS to know they are at a live event or the like to grant access to those others at the live event.

As used herein the term “users” refers to generally to any person (e.g., family member, friend, colleague, an individual attending live entertainment events or interests, and/or any other suitable person) linked to a user by way of one or more social media outlets of the present invention. For example, a social media contact may include two or more users attending a live music event, and/or any other suitable social media contact. As used herein, the term “user profile” may refer to any suitable information associated with a user. For example, a user profile may include a set of data representing information associated with a user's personal traits, preferences, settings, age, gender, income level, profession, family status, nationality, preferred genre of media content, media content viewing tendencies, etc.

As used herein the term “communicate” refers to using the communication system on the social media website for the purpose of chatting, communicating or the like with other individual users at the live entertainment event.

As used herein the term “app” refers to an abbreviation for an application and means a software program that can run on a computer or similar processing device designed to perform certain tasks or functions by itself, in combination with, and/or as a compliment to another software application. For the purposes of this disclosure, an app is used to access the website and communication system of the present invention.

As used herein the term “smart phone” refers to a mobile telephone with a relatively large set of functionality in addition to basic telephone features like making and receiving telephone calls and sending and receiving text messages, and basic address book and other ancillary functions. For example, in addition to basic mobile phone features, a smart phone may include web and e-mail access, calendar, a Global Positioning System (GPS), mapping, as well as a number of productivity and entertainment third-party applications. The smart phone may also include additional or more advanced hardware features than the basic phone, including, e.g., a larger display screen with higher resolution and touch-screen functionality, more memory, and a digital camera. In the disclosed examples including a smart phone and a basic phone, the smart phone may include more functions and less battery life than the basic phone.

As used herein, the terms “enhanced content” may include, but are not limited to, an advertisement, a promotional offer, interactive content, a video (e.g., a trailer, a video clip, etc.), an article (e.g., an online newspaper article), music, a map, a web page, a web-based search results list (e.g., a Google search results list), and/or any other content that may serve a particular implementation. In some examples, enhanced content may be associated with media content (e.g., may be associated with one or more characteristics of a media content for instance).

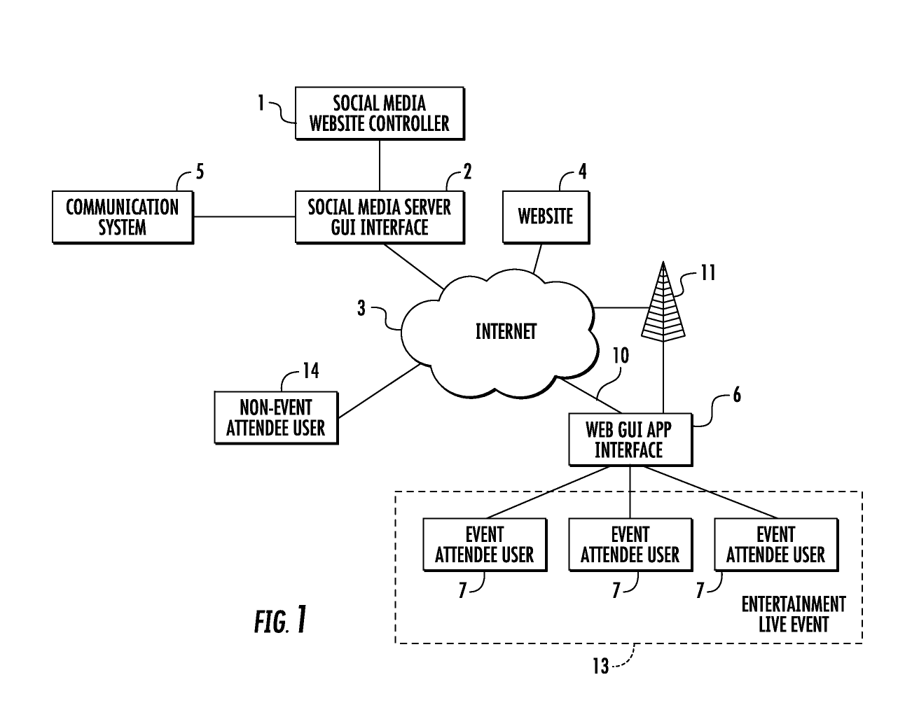

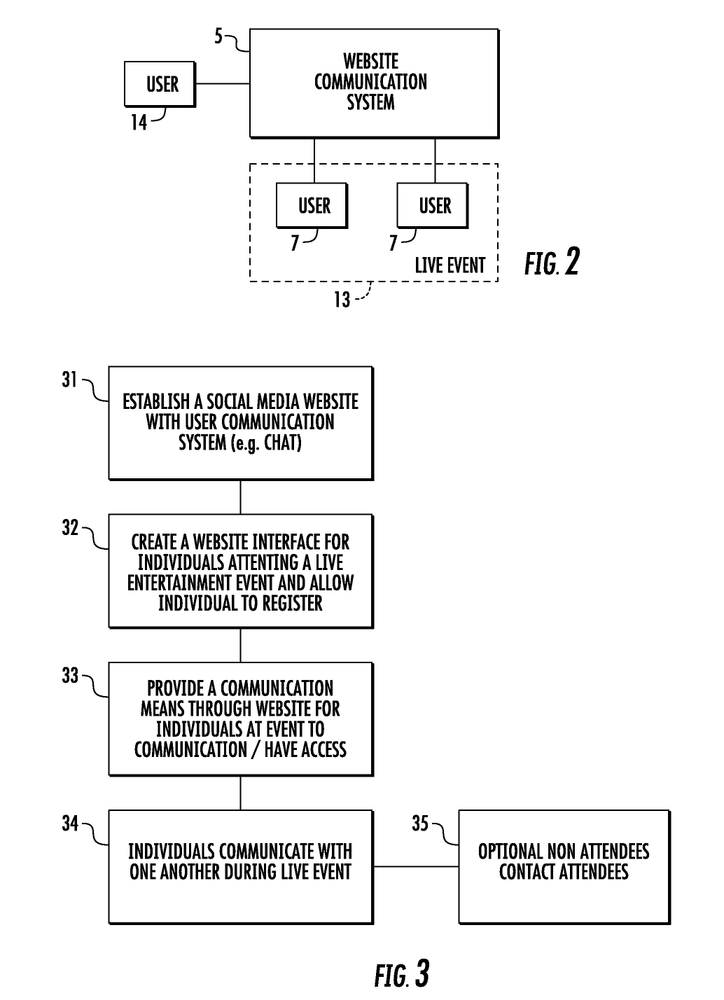

Now referring to the drawings, FIG. 1 is a schematic of the system of the present invention. In this embodiment there is a social media website controller 1 which can be a person or organization which oversees the day to day running of the social media website. The website has the information, data applications and the like, one or more servers 2 which has the ability to access the internet 3 and provide a GUI interface and set up users with access to the website 4 and the communication system 5 such that use of a web app 6 can provide user 7 access whether through wifi 10 or through a phone link of some type 11. The particular users 7 of the present embodiment are at live entertainment event 13. In this embodiment, a user not attending the live event 14 is also included as an additional embodiment. In FIG. 2, which is a schematic of users using the communication system, one can see that a plurality of users 7 at the live event 13 are utilizing the communication system 5 for the purpose of communicating between one another. In this embodiment there is a user 14 not attending the live event 13 also utilizing the communication system 5 (which is associated i.e. accessed with the website).

In FIG. 3 there is a flow diagram of the method of the present invention. In this view there is an established social media website with a user communication system 31 such as a chat or a video chat interface. The website creates a website interface for users attending a live entertainment event that allows users to register on the website and at a live event 32. A communication means is provided on the website for communication between users at the live event 33. The individuals then can communicate with one another at the live event 34. Optionally non-attendee users can also communicate with those at the live event using the social media website 35.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A system for the interaction of people using a social media outlet comprising:
a) a social media website associated with a live entertainment event;
b) a website interface that allows a plurality of website users attending the live event to become associated with the live entertainment event through the website;
c) a communication system associated with the website that allows the users attending the live event to communicate with one another during the live event.

2. The system according to claim 1 wherein the communication system is a website based chat system.

3. The system according to claim 1 wherein the interface is a website app on a portable computer.

4. The system according to claim 3 wherein the portable computer is a smart phone.

5. The system according to claim 1 which further comprises a communication system which allows individuals not at the live event to communicate with those at the live event.

6. The system according to claim 1 wherein the social media website comprises a server for storing and maintaining at least one of individual's information and live event information.

7. The system according to claim 1 wherein the website interface is a GUI.

8. A method of using a social media website and communication system comprising:
a) providing a social media website having a user interface and associating the website with a communication system and a live entertainment event;
b) allowing a plurality of users attending the live event to access the social media website via the user interface;
c) providing a means for the users attending the live event to access each other via the social media website;
d) allowing the users access to the communication system in order for the users to communicate with users they have accessed during the live event.

9. The method according to claim 8 which further comprises an individual not attending the live event being given access to the users attending the live event and the communication system.

10. The method according to claim 8 wherein the individual interface is an app for accessing the website.

11. The method according to claim 10 wherein the individual utilizes an app on a smart phone to access the social media website.

12. The method according to claim 8 which further comprises the social media website notifying users of live entertainment information.

13. The method according to claim 8 which further comprises the social media website providing users with information about the live event during the live event performance.

14. The method according to claim 8 wherein users attending the live entertainment event are chatting via the social medial website.

15. The method according to claim 8 wherein users accessing the website may be provided with enhanced content.
